(19) United States
(12) Patent Application Publication
(10) Pub. No.: US 2003/0046368 A1
(43) Pub. Date: Mar. 6, 2003

(54) Data transmission device, data receiving device, and network system

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/228,814

(22) Filed: Aug. 27, 2002

(30) Foreign Application Priority Data
Aug. 28, 2001 (JP) 2001-257521

(51) Int. Cl. G06F 15/16; H04M 11/00; H04N 1/00; H04J 15/00

(52) U.S. Cl. 709/219; 379/100.17; 358/425

(57) ABSTRACT

A data transmission device includes a transmitter for transmitting image data having a plurality of pages, page by page. A processor is provided for describing in a command header of transmit data, image data specified information which specifies that the image data attached to the transmit data is concerned with the image data having a plurality of pages transmitted by the transmitter.

### BACKGROUND OF THE INVENTION

1. Field of the Invention

The present invention relates to a data transmission device that transmits image data, a data receiving device that receives the image data based on the HTTP (Hypertext Transfer Protocol), and a network system, that includes the above devices.

2. Description of the Related Art

If image data is transmitted using the HTTP protocol, as shown in FIG. 6, a transmitting device 28 generally requests a destination device 29 to establish a TCP (Transmission Control Protocol) connection. The image data is transmitted after describing a command 22 such as “POST” that the image data is stored in a specified URL (Uniform Resource Locators) 23 in a command header 25. If the image data includes a plurality of pages, the image data is transmitted after describing page break data 30 in an attached image data. Meanwhile, the destination device 29 which receives the image data, transmits response data 27 which notifies the transmitting device 28 that the command has been processed. The TCP connection is broken when the transmitting device 28 requests to break the TCP connection.

However, if the transmitting image data includes many pages such as 100 or 200 pages, it takes a lot of time to scan the image data in a document, etc. and to generate transmit data 26 in the transmitting device 28. Moreover, as the destination device 29 decodes coded image data and divides the image data into several pages, after taking a lot of time to receive the transmit data 26, it also takes a lot of time from receiving the transmit data 26 to printing and delivering the image data.

It is an advantage of the present invention to provide a network system that can shorten the time from when the data transmission device begins to scan the image data to be transmitted to the time when the data receiving device completes the processes such as printing and delivering the received image data.

### SUMMARY OF THE INVENTION

A data transmission device that transmits image data, a data receiving device that receives the image data, based on the HTTP, and a network system that includes the devices of the present invention include the following features.

The data transmission device includes a transmission means for transmitting the image data having a plurality of pages, page by page and a description means for describing image data specified information which specifies that the image data attached to the transmit data is concerned with the image data having a plurality of pages in a command header of the transmit data to be transmitted by the transmission means.

The data transmission means in the data transmission device implements a series of processes more than once, wherein the series of processes includes a process for requesting the TCP connection, a transmission process for transmitting the transmit data including single page image data, a process for receiving response data from the data receiving device, and a process for requesting to break the TCP connection.

The data transmission device is equipped with a scanner for scanning the document having a plurality of pages and a generating means for generating the image data every time the scanner scans each page of the document, and the transmission means transmits the generated image data to the data receiving device sequentially.

The description means describes a command “POST” and URL (Uniform Resource Locators) of the image receiving device in the command header.

The data transmission device includes a telephone directory table that stores the URL of the destination.

The transmission means implements one process for requesting the TCP connection, a pair of processes including a process for transmitting a single page of image data and a process for receiving the response data more than once, and one process for requesting to break the TCP connection.

The data receiving device includes a receiving means for receiving the transmit data and a decision means for deciding whether or not the received image data is concerned with the image data having a plurality of pages based on the image data specified information of the received transmit data.

The data receiving device includes an executive means for processing the received transmit data sequentially in a predetermined manner. The executive means is a print means for printing the image data or a delivery means for delivering the image data.

The present invention shortens the time from when the document is scanned to the time when the receiving process such as printing and delivering is completed in the destination device.

Moreover, since the TCP connection established at first is not broken, the sequence can be simplified and further the communication time can be shorten.

### BRIEF DESCRIPTION OF THE DRAWINGS

FIG. 1 is a block diagram showing a configuration example of a facsimile server according to a preferred embodiment of the present invention.

FIG. 2 is a diagram showing a telephone directory table memorized in a RAM in the facsimile server according to the preferred embodiment of the present invention.

FIG. 3 is a block diagram showing an example of a network environment where the facsimile server is installed.

FIG. 4 is a sequence diagram showing a communication protocol in case that image data is transmitted using HTTP protocol between the facsimile server and a destination device according to a first preferred embodiment of the present invention.

FIG. 5 is a sequence diagram showing a communication protocol in case that the image data is transmitted using HTTP protocol between the facsimile server and the destination device according to a second preferred embodiment of the present invention.

FIG. 6 is a sequence diagram showing a communication protocol in case that the image data is transmitted using HTTP protocol between the facsimile server and the destination server of a prior art.

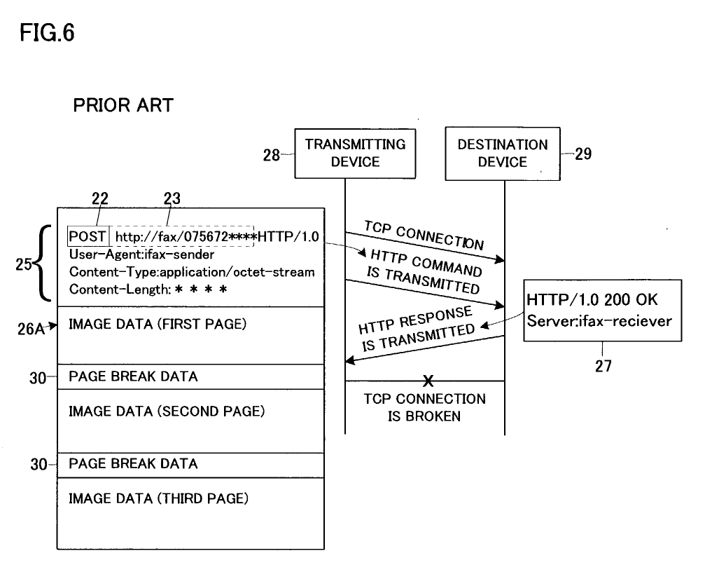

### DETAILED DESCRIPTION OF THE INVENTION

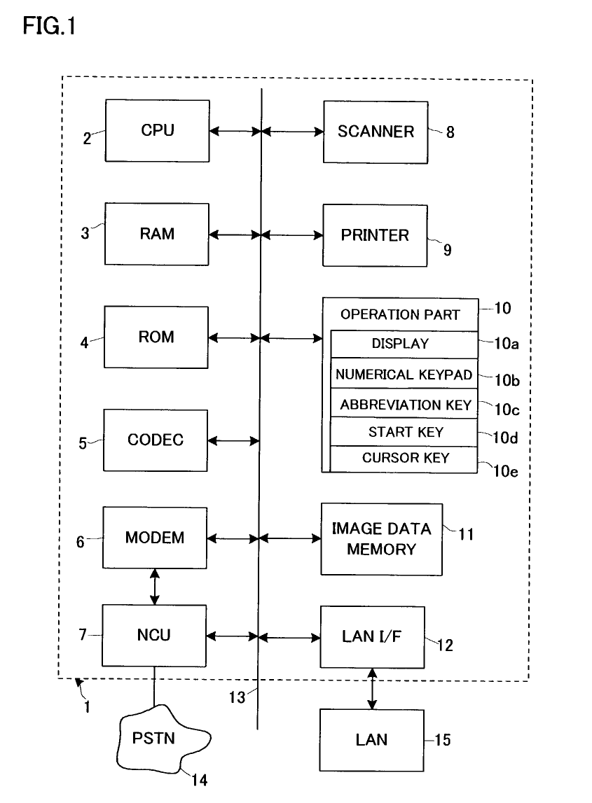

Hereinafter, a facsimile server is provided as a data transmission device according to a first preferred embodiment of the present invention will be described with reference to the drawings. FIG. 1 shows a configuration of a facsimile server 1. The facsimile server 1 includes a CPU (Central Processing Unit) 2, a RAM (Random Access Memory) 3, a ROM (Read Only Memory) 4, a CODEC 5, a MODEM 6, a NCU (Network Control Unit) 7, a scanner 8, a printer 9, an operation part 10, an image data memory 11, and a LAN I/F (Local Area Network-Interface) 12, and the respective devices 2˜12 are connected through a bus 13 so as to communicate with each other.

The CPU 2 controls the respective devices in the facsimile server 1 in accordance with a predetermined program.

The RAM 3 functions as a memory part for storing image data and a telephone directory table as described later in advance or as a memory part for storing data that is stored temporarily.

The ROM 4 stores various programs for controlling operations in each part of the facsimile server 1 by the CPU 2.

The CODEC 5 is provided for encoding and decoding data in conformity to a plurality of protocols. In other words, the CODEC 5 encodes the image data that is scanned in by the scanner 8, and decodes the received data, using MH, MR, and MMR coding schemes. Moreover, it also encodes and decodes the image data in conformity to the other image format such as a TIFF (Tagged Image File Format) used in computers.

The MODEM 6 modulates and demodulates receiving and transmitting data in conformity to the international telephone standards such as ITU-T (International Telecommunication Union) recommendation V. 34.

The NCU 7 is a network control unit for making a call or breaking a connection by controlling a telephone line and connected to a PSTN (Public Switched Telephone Networks) 14.

The scanner 8 scans an image in a document and outputs image data translated into two-valued black and white patterns.

The printer 9 includes devices adopting an electrophotographic system, forms an image on a recording paper using the received image data, and prints out the recording paper.

The operation part 10 includes a display 10a which displays information on the state of the facsimile server 1 and various operation guidance on a screen, a numerical keypad 10b for inputting such as facsimile numbers, an abbreviation key 10c for transmitting using an abbreviation number, a start key 10d for starting a process such as scanning a document, and a cursor key 10e for moving a reversing cursor in the display 10a, and they are operated in the operation part 10.

The image data memory 11 stores the image data allocated URL in a predetermined area as well as stores the image data received by a G3 facsimile and an Internet facsimile.

The LAN I/F 12 includes an interface for a LAN (Local Area Network) 15 and connects the LAN 15 and the facsimile server 1 so as to communicate with each other.

The facsimile server 1 is installed with the TCP/IP (Transmission Control Protocol/Internet Protocol) and provides a feature of receiving and transmitting image data using HTTP (Hypertext Transfer Protocol) protocol as well as a feature of receiving and transmitting image data of the document using the Internet facsimile (e-mail) or the G3 facsimile. In addition, HTTP is a communication protocol for receiving and transmitting files such as HTML (Hypertext Markup Language) files between a WWW (World Wide Web) server and a WWW client through the Internet for example, and it is defined in RFC (Request for Comments) 1945 and 2616, etc.

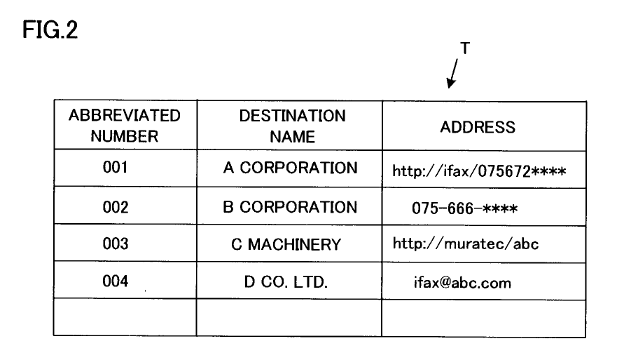

The facsimile server 1 stores a telephone directory table T as shown in FIG. 2 in a predetermined area of the RAM 3. The telephone directory table T includes a “destination” column that stores destination names and an “address” column that stores destination addresses such as a URL, a mail address, or a facsimile number in every abbreviation number.

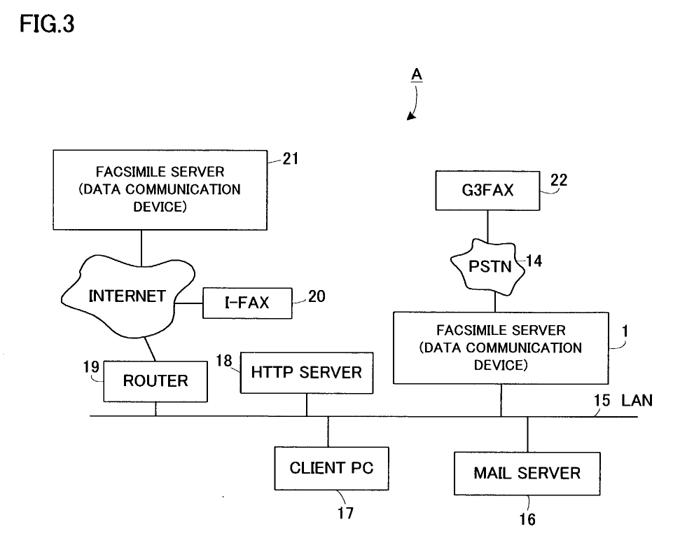

The facsimile server 1 is installed to be used in a network environment A as shown in FIG. 3, for example. More specifically, the facsimile server 1 is connected to a mail server 16, a client PC 17, a HTTP server 18, and a router 19 through the LAN 15 so as to communicate with each other, and can communicate with an Internet facsimile device 20 and a facsimile server 21 which has the same specification as the one in the facsimile server 1 through the Internet. Moreover, the facsimile server 1 can receive and transmit the G3 facsimile to and from the other G3 facsimile terminal 22 through the PSTN 14.

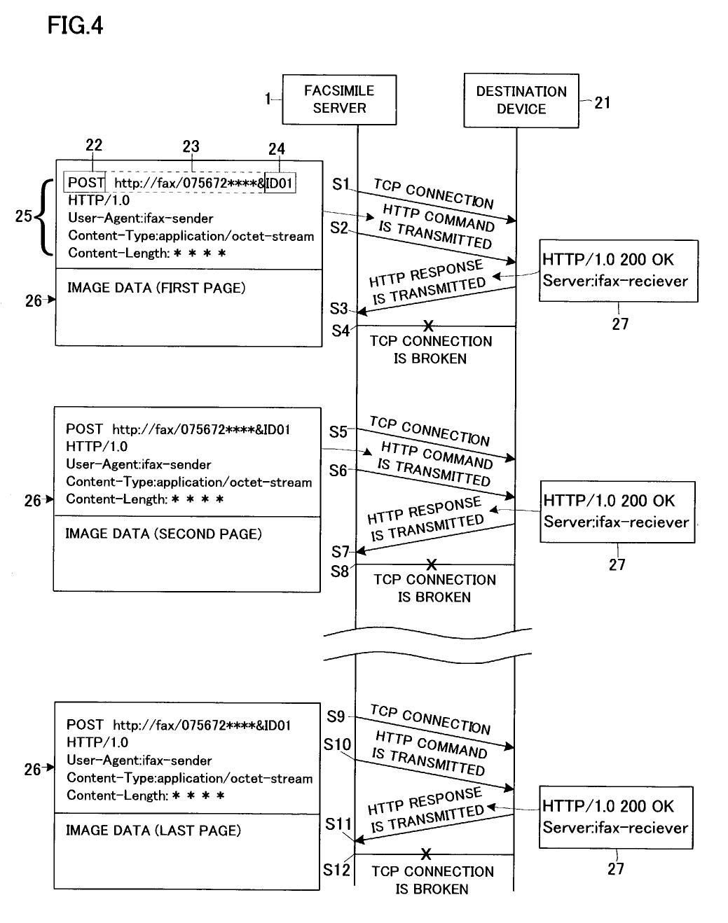

Hereinafter, the operation of the image data having a plurality of pages transmitted from the facsimile server 1 to the destination device having a function of HTTP server such as the facsimile server 21 will be described with reference to a sequence diagram as shown in FIG. 4. Additionally, the operations of the facsimile server 1 and the destination device (facsimile server) 21 are carried out in accordance with a command issued by the CPU 2, based on such as a control program stored in each ROM 4.

An operator sets document having a plurality of pages on the scanner 8 and inputs to specify a transmitting address using the abbreviation key 10c of the operation part. If the specified transmitting address is the URL allocated in the abbreviation numbers “001” or “003” as shown in the telephone directory table T of FIG. 2, the facsimile server 1 requests the destination device 21 to establish the TCP connection (S1), and the facsimile server 1 describes the command “POST” 22, the URL 23 where the command 22 is carries out, image data specified information 24 which specifies that the attached image data is concerned with the image data of the document having a plurality of pages, and the other information, in the command header 25. After that, the facsimile server 1 makes a transmit data 26 by attaching the first page image data to the command header 25, and transmits the transmit data 26 to the destination device 21 (S2). When receiving response data 27 which notifies that the command 22 is processed from the destination device 21 which have received the transmit data 26 (S3), the facsimile server 1 requests to break the TCP connection (S4).

Sequentially, the facsimile server 1 requests to establish the TCP connection again (S5), transmits the transmit data 26 where the second page of the image data is attached to the command header 25 which is the same as the one transmitted in the above S2 to the destination device 21 (S6), and receives a response data 27 from the destination device 21 and requests to break the TCP connection (S7 and S8).

The same process as described above is applied to the following pages, and the facsimile server 1 establishes the TCP connection, transmits the data 26 where each page of the image data is attached to the command header 25, receives the response data 27, and requests to break the TCP connection, and the image data is transmitted repeatedly page by page until the final page of the image data has been completely transmitted (S9˜S12).

The destination device 21 can determine that the respective image data received as described above is included among the same document, based on the image data specified information 24 described in the command header 25 and each page of the image data is received in the order of the page number, so that the respective image data can be identified even if an image data is received from the other device before receiving the fourth page of the image data after receiving the third page of the image data.

When the image data is transmitted page by page as described above, the time from that the document is started to scan to that the receiving process such as printing is completed in the destination device 21 can be shorten. More specifically, as the facsimile server 1 generates image data every time scanning one page of the document that is set on the scanner 8 to transmit each image data sequentially and the destination device 21 receives the image data page by page to implement the processes such as printing and delivering sequentially, the time from that the first page of the document is started to scan in the facsimile server 1 to that the process such as printing the final page of the image data is completed in the destination device 21 can be shorten drastically.

Next, a second preferred embodiment of the present invention will be described. A facsimile server 1A as the data communication device according to the second preferred embodiment also has the same configuration as the facsimile server 1 according to the first preferred embodiment, and stores the data table T as shown in FIG. 2 in the RAM 3. Moreover, the facsimile server 1A is installed to be use in the network environment A as shown in FIG. 3.

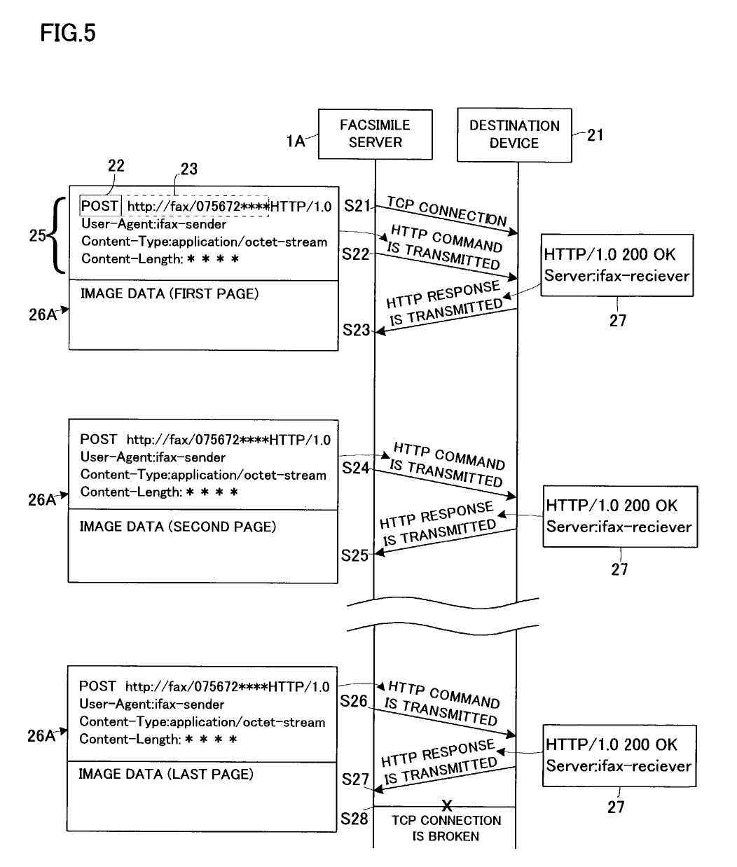

Hereinafter, the operation that the image data of a plurality of pages is transmitted from the facsimile server 1A to the facsimile server 21 having a function of the HTTP server will be described with reference to a sequence diagram as shown in FIG. 5. In addition, the operation of the facsimile servers 1A, 21 that is described with reference to the sequence diagram is carried out in accordance with the command issued by the CPU 2, based on the control program, etc. stored in each ROM 4. Moreover, if necessary to make the destination device recognize the start of the operation, the recognition can be carried out by including the information that notifies the necessity in the first transmit data. For example, it can be a signal to start the operation in case of specifying certain URL.

An operator sets documents having a plurality of pages on the scanner 8 and inputs a transmitting address using the abbreviation key 10c in the operation part. If the specified transmitting address as the URL allocated in the abbreviation numbers “001” or “003” shown in the telephone directory table T of FIG. 2, the facsimile server 1 requests the destination device 21 to establish a TCP connection (S21). The facsimile server 1 describes the command “POST” 22, the URL 23 where the command 22 is carried out, and the other information in the command header 25. After that, the facsimile server 1 makes a transmit data 26A by attaching the first page image data to the command header 25, and transmits the transmit data 26A to the destination device 21 (S22). After that, when receiving response data 27 which notifies that the command 22 is processed from the destination device 21 which received transmit data 26A (S23), the facsimile server 1 transmit the transmit data 26A that the second page of the image data is attached to the command header 25 like the one transmitted in the above S22 to the destination device 21 and receives response data 27 from the destination device 21 which receives transmit data 26A, without requesting to break the TCP connection (S25).

As described above, the facsimile server 1A transmits the entire image data of the subsequent pages, page by page until the final page of the image data is completely transmitted in the same TCP connection without breaking the TCP connection established in the above S21. The TCP connection is requested to break after transmitting the final page image data and receiving the response data (S27 and S28).

In this way, a series of full pages of image data is transmitted page by page in the same TCP connection without breaking the TCP connection which is established between the facsimile server 1A and the destination device 21 at first. Thus, the time from that the first page of the document is scanned to that the process such as printing the final page of the image data is completed in the destination device 21 can also be shorten drastically, same as the case in the facsimile server according to the first preferred embodiment. Additionally, as the facsimile server 1A does not request to break the TCP connection that is established in the beginning on the way, the destination device can recognize that each page of the received image data is concerned with the image data of the same document even if the image data specified information 24, etc. to be described in the command header 25 in the first preferred embodiment is not described. Thus, the sequence can be simplified and further the communication time can be reduced.

What is claimed is:

1. A data transmission device that transmits image data using HTTP (Hyper Text Transport Protocol) comprising:
a transmission means for transmitting image data having a plurality of pages, page by page; and
a description means for describing in a command header of transmit data, image data specified information which specifies that the image data attached to the transmit data is concerned with the image data having a plurality of pages transmitted by the transmission means.

2. The data transmission device according to claim 1, wherein the transmission means implements a series of processes more than once, that the series of processes includes a process of requesting a TCP connection, a process of transmitting the transmit data including a single page of the image data, process of receiving response data from a data receiving device, and a process of requesting to break the TCP connection.

3. The data transmission device according to claim 1 further comprising:
a scanner for scanning a document having a plurality of pages; and
an image data generating means for generating the image data every time the scanner scans in the document page by page,
wherein the transmission means transmits the generated image data sequentially to a data receiving device.

4. The data transmission device according to claim 1, wherein the description means describes a command “POST” and a URL (Uniform Resource Locators) in the command header.

5. The data transmission device according to claim 4, further comprising a telephone directory table where the URL of destinations are stored.

6. The data transmission device according to claim 1, wherein the transmission means implements one process of requesting the TCP connection, a pair of processes including the process of transmitting a single page of the image data and the receiving process of the response data with keeping the TCP connection, and one process of requesting to break the TCP connection more than once.

7. A data receiving device that receives transmit data is comprised of image data and image data specified information which specifies that the image data having a plurality of pages, comprising:
a receiving means for receiving transmit data; and
a determining means for determining whether or not received image data is concerned with the image data having a plurality of pages, based on the image data specified information.

8. The data receiving device according to claim 7, further comprising an executive means for processing the received transmit data sequentially in a predetermined manner.

9. The data receiving device according to claim 8, wherein the executive means is a printer for printing the image data.

10. The data receiving device according to claim 8, wherein the executive means is a delivery means for delivering image data.

11. A network system comprising:
a data transmission device that transmits image data and a data receiving device that receives the image data using HTTP, wherein the data transmission device including:
a transmission means for transmitting image data comprised of a plurality of pages by one page; and
a description means for describing an image data specified information which specifies that the image data attached to the transmit data is concerned with the image data comprised of a plurality of pages in the command header of the transmit data which is transmitted by the transmission means.

12. The network system according to claim 11, wherein the transmission means implements a series of processes more than once, that the series of processes are includes a process of requesting the TCP connection, a process of transmitting the transmit data including a single page image data, a process of receiving response data from a data receiving device, and a process of requesting to break the TCP connection.

13. The network system according to claim 11 further comprising:
a scanner for scanning a document having a plurality of pages; and,
an image data generating means for generating the image data every time the scanner scans in the document page by page,
wherein the transmission means transmits the generated image data to a data receiving means sequentially.

14. The network system according to claim 11, wherein the description means describes the command “POST” and a URL (Uniform Resource Locators) of the data receiving device in the command header.

15. The network system according to claim 14, further comprising a telephone directory table where the URL of destinations are stored.

16. The network system according to claim 11, wherein the transmission means implements one request process of the TCP connection, a pair of processes including the process of transmitting a single page image data and a process of receiving response data with keeping the TCP connection, and one request process of breaking the TCP connection more than once.

17. The network system according to claim 11, wherein the data receiving device comprises a receiving means for receiving transmission data and a determining means for determining whether or not received image data is concerned with the image data having a plurality of pages, based on image data specified information of the received transmit data.

18. The network system according to claim 17, wherein the data receiving device comprising an executive means for processing the received data sequentially in a predetermined manner.

19. The network system according to claim 18, wherein the executive means is a printer for printing the image data.

20. The network system according to claim 18, wherein the executive means is a delivery means for delivering the image data.

21. A data transmission device that transmits image data using HTTP (Hyper Text Transport Protocol) comprising:
a transmitter for transmitting image data having a plurality of pages, page by page; and
a processor for describing in a command header of transmit data, image data specified information which specifies that the image data attached to the transmit data is concerned with the image data having a plurality of pages transmitted by the transmitter.

22. A method for transmitting data comprising:
transmitting image data having a plurality of pages, page by page using HTTP (Hyper Text Transport Protocol); and
describing in a command header of transmit data, image data specified information which specifies that the image data attached to the transmit data is concerned with the image data having a plurality of pages.
